(19) United States
(12) Patent Application Publication
(10) Pub. No.: US 2014/0164960 A1
(43) Pub. Date: Jun. 12, 2014

(54) METHOD FOR GROUPING AND MANAGING WEB PAGES

(71) Applicant: Acer Incorporated, New Taipei City (TW)

(72) Inventors: Chuan-Yi Kuo, New Taipei City (TW); Yu-Chun Chen, New Taipei City (TW)

(73) Assignee: Acer Incorporated, New Taipei City (TW)

(21) Appl. No.: 14/085,799

(22) Filed: Nov. 21, 2013

(30) Foreign Application Priority Data
Dec. 12, 2012 (TW) 101146958

(51) Int. Cl. G06F 3/0484; G06F 17/22

(52) U.S. Cl. CPC G06F 3/0484; G06F 17/2247
USPC 715/760

(57) ABSTRACT

A method for grouping and managing web pages, adapted to an electronic apparatus, is provided. In the method, a plurality of web pages are opened in a browser, and a plurality of tabs corresponding to the web pages are sequentially displayed in a tab bar of the browser. Then, a drag operation performed on a first tab of the tabs is received. When the first tab is dragged to a second tab and overlapped with the second tab, a grouping interface is extendedly displayed from the second tab. When the drag operation is ended within the grouping interface, the first tab is added to a tab group of the second tab and the grouping interface is closed.

### CROSS-REFERENCE TO RELATED APPLICATION

This application claims the priority benefit of Taiwan application serial no. 101146958, filed on Dec. 12, 2012. The entirety of the above-mentioned patent application is hereby incorporated by reference herein and made a part of this specification.

### FIELD OF THE INVENTION

The invention relates to a method for browsing web pages, and more particularly, relates to a method of grouping browser tabs for managing web pages.

DESCRIPTION OF RELATED ART

Along with the popularization of the Internet, using the browser to connect to the Internet for browsing web pages or gathering information has become one of modern life's routine. By observing the habits of browsing web pages of general users, it can be found that while the users browse web pages, they are often attracted by one of information therein and wish to view further details of the information. As the users do not want to leave the current page, they are used to keep the current page and choose to open a new window or a new tab for viewing the desired information.

However, since the contents of the web pages are quite diverse, the users may find other desired information after they open a new web window or a new tab for browsing information. As so, in order to keep the current web page, the users have to open another window or tab for linking and searching the desired information. As the time passes by, the users usually open too many windows on the screen or create too many tabs in a window. Consequently, as the users want to return to the previously browsed web page, they need to search over the enormous amounts of windows and tabs, one by one, which is very inconvenient.

### SUMMARY OF THE INVENTION

In view of this, the invention provides a method for grouping and managing web pages, so as to efficiently manage the web pages.

The invention provides a method for grouping and managing web pages, which is adapted to an electronic device. In the method, a plurality of web pages are opened in a browser, and a plurality of tabs corresponding to the web pages are sequentially displayed in a tab bar of the browser. Next, a drag operation performed on the first tab of the tabs is received. When the first tab is dragged to a second tab and overlapping with the second tab, a grouping interface is extendedly displayed from the second tab. When the drag operation is ended within the grouping interface, the first tab is added to a tab group of the second tab, and the grouping interface is closed.

Based on the above, the method of grouping and managing web pages of the invention combines multiple tabs into a tab group through dragging the tabs. The method further provides users to edit the tabs in the tab group through either a pull-down menu or an extendedly displayed grouping interface, thereby achieving the goal of efficiently managing web pages.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method of grouping and managing web pages according to an embodiment of the invention.

FIG. 2A to FIG. 2E are examples illustrating a method of grouping and managing web pages according to an embodiment of the invention.

FIG. 3 is a flowchart illustrating a method of grouping and managing web pages according to an embodiment of the invention.

FIG. 4 is an example illustrating a method of grouping and managing web pages according to an embodiment of the invention.

FIG. 5 is a flowchart illustrating a method of grouping and managing web pages according to an embodiment of the invention.

FIG. 6 is an example illustrating a method of grouping and managing web pages according to an embodiment of the invention.

FIG. 7 is an example illustrating a method of grouping and managing web pages according to an embodiment of the invention.

FIG. 8A and FIG. 8B are examples illustrating a method of grouping and managing web pages according to an embodiment of the invention.

### DESCRIPTION OF THE EMBODIMENTS

By observing the habits of browsing web pages of a user, it can be found that when the current page needs to be kept, the user often choose to open other web pages by creating new tabs in the same window, so as to switch between the web pages. Those web pages are typically relevant to each other at certain levels. In order to solve a problem of having too many tabs, the invention provides a mechanism of grouping and managing tabs, thus the user can combine the tabs having the same topic or homogeneity into one tab through dragging the tabs. When the user needs to see the web pages, he/she can then expand the tab or edit the tab. In this way, the invention can offer a much brief and clear tab bar for the user to, operate, and also allows the user to manage the web pages conveniently.

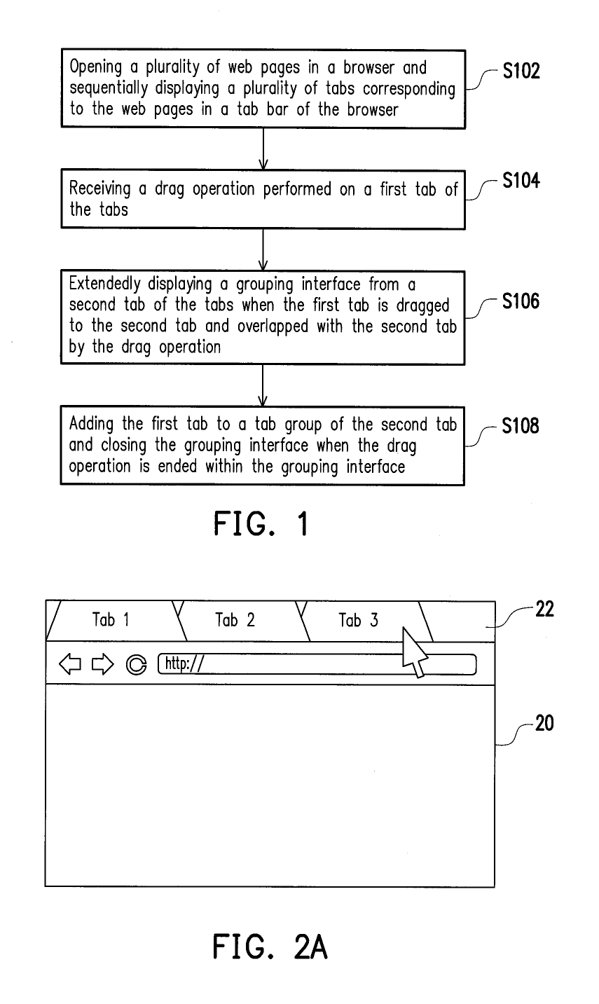

FIG. 1 is a flowchart illustrating a method of grouping and managing web pages according to an embodiment of the invention. In FIG. 1, the method of the present embodiment is suitable for an electronic device, such as a mobile phone, a smart phone, a personal digital assistant (PDA), a PDA phone, a tablet PC, a notebook computer, or a desktop computer, and the steps thereof are respectively described as follows.

First, the electronic device opens a plurality of web pages in a browser according to operations of a user and sequentially displays a plurality of tabs corresponding to the web pages in a tab bar of the browser (step S102). The tab bar of the browser is, for example, displayed at the top of a main frame, and the web page corresponding to the currently used tab is displayed at the center of the main frame.

Subsequently, the electronic device receives a drag operation performed by the user on a first tab of the displayed tabs (step S104). The drag operation is, for example, a drag action on the tab displayed on the screen of the electronic device indirectly performed by the user using a pointing device, such as a mouse, or a touch pad. On the other hand, the dragging operation may be an operation of the user directly dragging the preferred tabs on the touch screen, but is not limited thereto.

In the process of dragging the first tab by the user, the electronic device persistently detects a moving path of the first tab and determines whether the first tab go through other objects on the screen. When the first tab is dragged to a second tab and overlapped with the second tab by the drag operation, the electronic device extendedly displays a grouping interface from the second tab (step S106). In one embodiment, the grouping interface is, for example, a circular area centered at the second tab, which allows the users to easily insert the first tab and complete the operation. In another embodiment, the grouping interface can also display tab icons of the tabs in a tab group of the second tab, so the users can insert the first tab and further decide the location of the first tab in the tab group.

Finally, when the drag operation is ended within the grouping interface, the electronic device adds the first tab to the tab group of the second tab and closes the grouping interface (step S108), thereby completing the operation of grouping tabs. It should be noted that if the second tab is already a group tab containing a plurality of tabs, the first tab will be added to this existing tab group. On the other hand, if the second tab is only a single tab instead of a group tab, then after the first tab is added, the electronic device creates a new tab group and displays a group icon in the second tab, so as to indicate the second tab as a group tab.

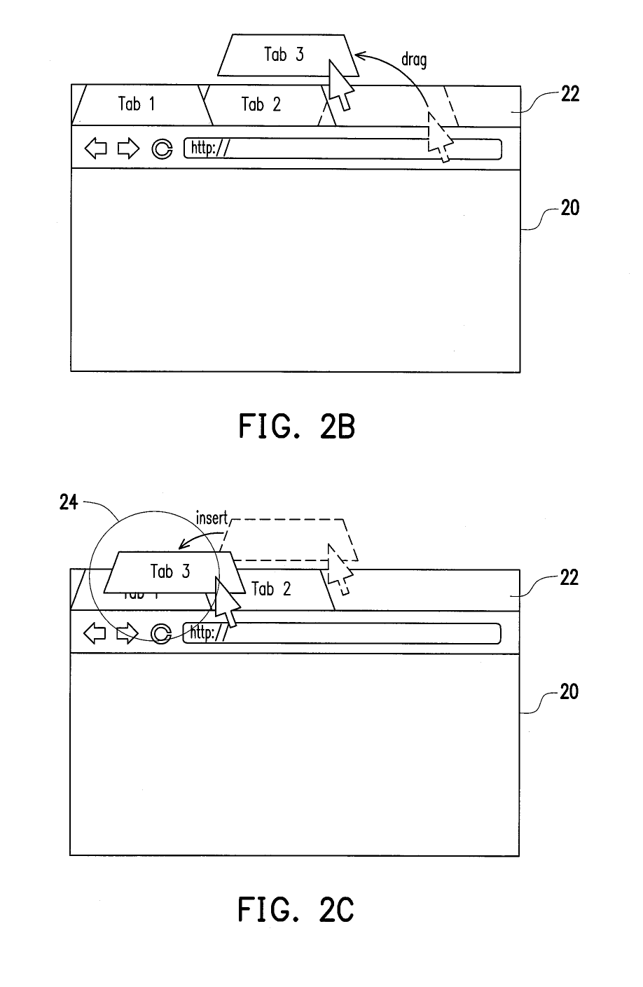

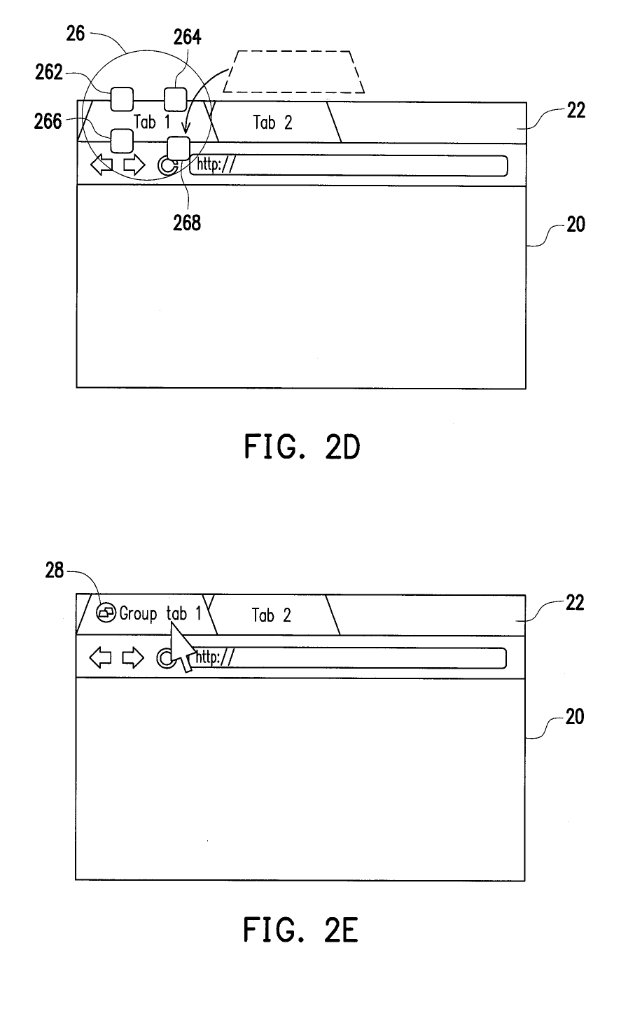

For instance, FIG. 2A to FIG. 2E are examples illustrating a method of grouping and managing web pages according to an embodiment of the invention. Please referring to FIG. 2A, it is assumed the user has already opened three web pages in the browser 20, and the tabs 1, 2, and 3 corresponding to the web pages are displayed in the tab bar 22 of the browser 20. Next, in FIG. 2B, when the user first clicks on the tab 3 and drags the tab 3, the tab 3 is moved along with the dragging direction. Then, in FIG. 2C, as the tab 3 is moved to the tab 1 and overlapped with the tab 1, a circular grouping interface 24 is extendedly displayed from the tab 1 in a translucent manner by the browser 20, which allows the user to insert the tab 3. On the other hand, in FIG. 2D, when the tab 3 is moved to the tab 1 and overlapped with the tab 1, the circular grouping interface 26 is extendedly displayed from the tab 1 in a translucent manner by the browser 20, and the tab icons 262, 264, and 266 corresponding to the tabs in the tab group of the tab 1 are displayed in the grouping interface 26. When the dragged tab 3 enters the grouping interface 26, the dragged tab 3 is transformed into the tab icon 268, which allows the user to insert the tab 3. The user can continuously drag the tab icon 268 to adjust the location of the tab icon 268 within the grouping interface 26, thereby adjusting the order of the dragged tab 3 under the tab group. Finally, please referring to FIG. 2E, when the user inserts the tab 3 into the grouping interface 24 and the drag operation is ended within the grouping interface 24, the electronic device adds the tab 3 to the tab group of the tab 1. The tab 1 is renamed as group tab 1, and the group icon 28 is displayed within the group tab 1 for indicating the tab 1 as a group tab.

By the above method, the user can complete the tab grouping by simple drag operations, so as to easily manage the opened web pages. It should be noted that, for the tabs that have already established a tab group, the invention further provides a complete editing mechanism, which allows the user to adjust the contents of the tab group, add the tabs back to the tab bar, or display the tabs in an individual window. The embodiments are provided below for detailed description.

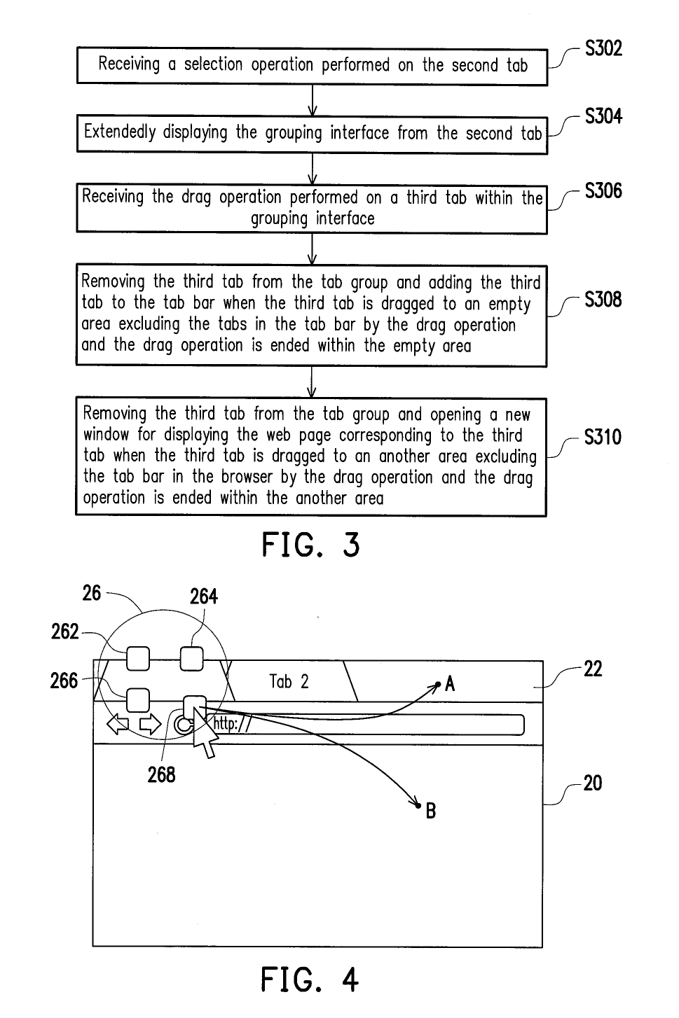

FIG. 3 is a flowchart illustrating a method of grouping and managing web pages according to an embodiment of the invention. Please referring to FIG. 3, the method of this embodiment follows the step S108 of the previous embodiment. The method uses aforesaid grouping interface to edit the tabs in the tab group, and the steps thereof are respectively described in detail as follows.

First, the electronic device receives a selection operation performed on the second tab by the user (step S302), and then extendedly displays the grouping interface from the second tab (step S304). The selection operation is, for example, performed in the way that the user selects the second tab by clicking a left button of a mouse, or taps the second tab directly by fingers, and the embodiment is not limited thereto. The grouping interface may, for example, display a part or all of the tab icons in the same tab group.

Subsequently, the electronic device receives a drag operation performed on a third tab in the grouping interface by the user (step S306). At this time, the electron device tracks the direction of the drag operation, and when the third tab is dragged to an empty area excluding the tabs in the tab bar by the drag operation and the drag operation is ended within the empty area, the electronic device removes the third tab from the tab group and adds the third tab to the tab bar (step S308). Thereby, the electronic device can remove the third tab from the tab group, and at the same time add the third tab back to the tab bar.

On the other hand, when the third tab is dragged to a web page currently displayed in the browser by the drag operation and the drag operation is ended within the web page, the electronic device removes the third tab from the tab group and opens a new window for displaying the web page corresponding to the third tab (step S310). Thereby, the electronic device can remove the third tab from the tab group, and at the same time display the web page corresponding to the third tab in an individual window.

For instance, FIG. 4 is an example illustrating a method of grouping and managing web pages according to an embodiment of the invention. Please referring to FIG. 4, this embodiment follows FIG. 2E, i.e. after the tab 3 is added to the tab group of the tab 1. When the user clicks on the tab 1, the electronic device extendedly displays a grouping interface 26 from the tab 1, and the tab icons 262, 264, 266, and 268 of the tab group are displayed therein. At this time, if the user clicks on the tab icon 268 and drags the same to an empty area of the tab bar 22 (e.g. point A), the electronic device removes the tab 3 corresponding to the tab icon 268 from the tab group and add the tab 3 back to the tab bar 22 at the same time. One the other hand, if the user clicks on the tab icon 268 and drags the same to another area (e.g. point B) excluding the tab bar 22 in the browser, the electronic device removes the tab 3 corresponding to the tab icon 268 from the tab group, and at the same time opens a new window for displaying the web page corresponding to the tab 3.

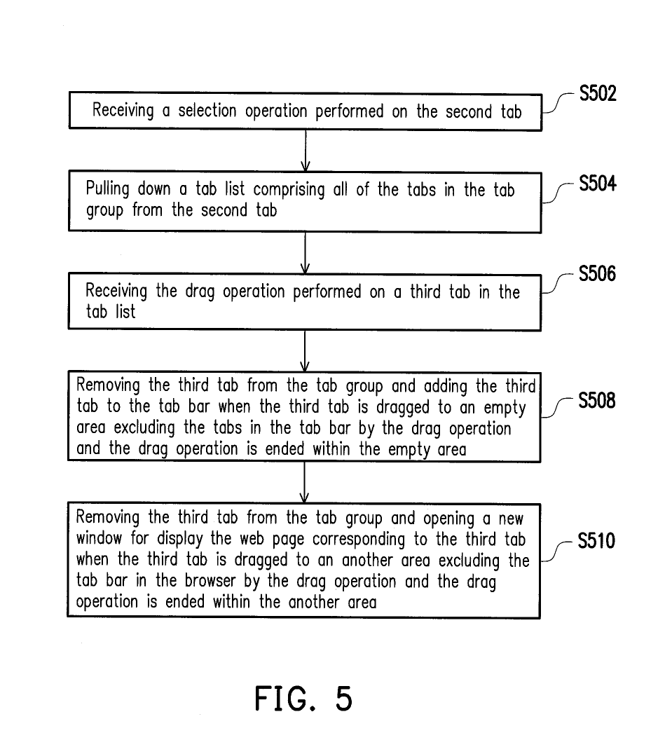

On the other hand, FIG. 5 is a flowchart illustrating a method of grouping and managing web pages according to an embodiment of the invention. Please referring to FIG. 5, the method of this embodiment follows the step S108 of the previous embodiment. The method provides a method of pulling down a tab list so as to edit the tabs in the tab group, and the steps thereof are respectively described in detail as follows.

First, the electronic device receives a selection operation performed on the second tab by the user (step S502), and then pulls down a tab list including all the tabs of the tab group from the second tab (step S504).

Subsequently, the electronic device receives a drag operation performed on the third tab in the tab list by the user (step S506). At this time, the electron device tracks the direction of the drag operation, and when the third tab is dragged to an empty area excluding the tabs in the tab bar by the drag operation and the drag operation is ended within the empty area, the electronic device removes the third tab from the tab group and adds the third tab to the tab bar (step S508). Thereby, the electronic device can remove the third tab from the tab group, and at the same time add the third tab back to the tab bar.

On the other hand, when the third tab is dragged to a web page currently displayed in the browser by the drag operation and the drag operation is ended within the web page, the electronic device removes the third tab from the tab group and opens a new window for displaying the web page corresponding to the third tab in the new window (step S510). Thereby, the electronic device can remove the third tab from the tab group, and at the same time display the web page corresponding to the third tab in an individual window.

It should be noted that as the tab list is displayed, the embodiment still allows the user to drag other tabs from the tab bar to the tab list, so as to add other tabs to the tab group of the second tab, and display the tab being dragged in the tab list.

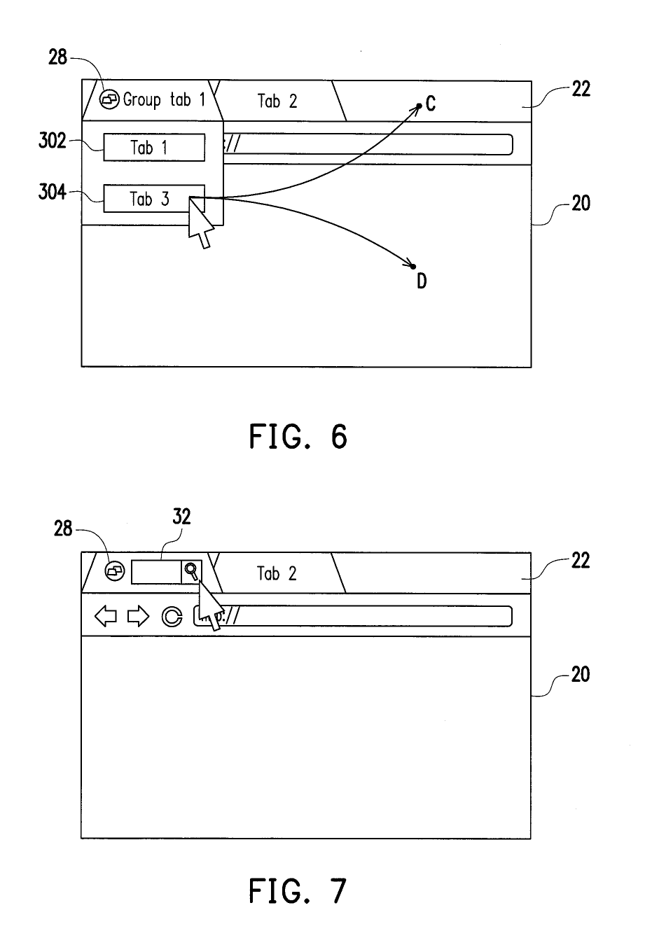

For instance, FIG. 6 is an example illustrating a method of grouping and managing web pages according to an embodiment of the invention. Please referring to FIG. 6, this embodiment follows FIG. 3, i.e. after the tab 3 is added to the tab group of the tab 1. When the user clicks on the tab 1, the electronic device pulls down a tab list 30 from the tab 1, and displays the tabs 302 and 304 of a tab group in the tab list 30. At this time, if the user clicks on the tab 304 and drags the same to an empty area of the tab bar 32 (e.g. point C), the electronic device removes the tab 304 from the tab group and adds the tab 304 to the tab bar 32 at the same time. On the other hand, if the user clicks on the tab 304 and drags the same to other area excluding the tab bar 32 (e.g. point D) in the browser, the electronic device removes the tab 3 corresponding to the tab 304 from the tab group, and at the same time opens a new window for displaying the web page corresponding to the tab 3.

In addition, in order to provide the user with ease to search web pages corresponding to specific tabs in a tab group, the invention further provides a search mechanism, in which a search bar is displayed within the group tab for receiving the texts entered by the user, so as to search the corresponding tabs under the tab group. For instance, FIG. 7 is an example illustrating a method of grouping and managing web pages according to an embodiment of the invention. Please referring to FIG. 7, in this embodiment, besides the group icon 28 is displayed in the group tab, when the user clicks on the group tab, a search bar 32 is further displayed in order for the users to enter texts for searching the desired tabs.

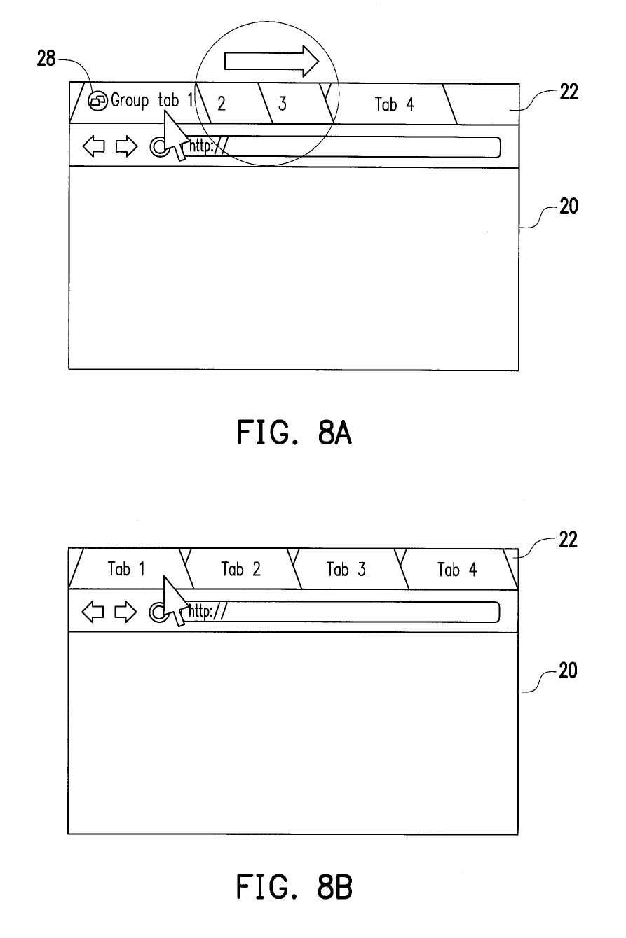

Furthermore, in order to provide the user with ease to browse all tabs within the tab group, the invention further allows the tab group to be expanded according to the user's operation, such that the users can view all of the tabs in the tab group. For instance, FIG. 8A to FIG. 8B are examples illustrating a method of grouping and managing web pages according to an embodiment of the invention. Please referring to FIG. 8A, when the user perform an operation of double-clicking on the group tab 1, the electronic device (rightward) extendedly displays all the tabs in the tab group from the group tab 1 in the tab bar, and finally displays the tabs 1, 2, and 3 as shown in FIG. 8B, such that the user is able to click on the tabs to browse the desired web pages.

It is noted herein that, in order to make the tabs easy to be found and keep the tab's information clear, the present invention further provides two mechanisms for the user to operate.

In the first mechanism, when the user add a first tab to a tab group of a second tab, a group icon indicating a number of tabs included in the tab group is displayed within the second tab. At this time, when the user performs an operation like double-clicking on the second tab, the second tab is unfolded and all the tabs in the tab group are expendedly displayed from the second tab in the tab bar, such that the user is able to see all the tabs in the tab group.

In the second mechanism, when the user clicks (e.g. right clicks) on a certain object (e.g. a link) in a current web page and selects to open in a new tab from a pop-out menu, a web page corresponding to the object is opened in a new tab and since the web page is relevant to the original web page, the new tab is automatically added to the tab group of the tab of the original web page. Similar to the first mechanism, a group icon indicating a number of tabs included in the tab group is displayed within the tab of the original web page. At this time, when the user performs an operation like double-clicking on this tab, the tab is unfolded and all the tabs in the tab group are expendedly displayed from the tab in the tab bar, such that the user is able to see all the tabs in the tab group.

Based on the above, the method of grouping and managing web pages of the invention combines multiple tabs into a tab group through dragging tabs so as to classify and manage the tabs. In addition, the invention further provides the user to perform operations, such as searching, removing, or expanding, on the tabs in the tab group through clicking tabs, double-clicking tab groups, and so on, thereby achieving the goal of conveniently managing web pages.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A method of grouping and managing web pages, adapted to an electronic device, the method comprising:
opening a plurality of web pages in a browser and sequentially displaying a plurality of tabs corresponding to the web pages in a tab bar of the browser;
receiving a drag operation performed on a first tab of the tabs;
extendedly displaying a grouping interface from a second tab of the tabs when the first tab is dragged to the second tab and overlapped with the second tab by the drag operation; and
adding the first tab to a tab group of the second tab and closing the grouping interface when the drag operation is ended within the grouping interface.

2. The method of grouping and managing web pages as claimed in claim 1, wherein the step of extendedly displaying the grouping interface from the second tab further comprises:
displaying a plurality of tab icons corresponding to the tabs in the tab group of the second tab in the grouping interface.

3. The method of grouping and managing web pages as claimed in claim 1, wherein the step of adding the first tab to the tab group and closing the grouping interface further comprise:
displaying a group icon in the second tab for indicating the second tab as a group tab.

4. The method of grouping and managing web pages as claimed in claim 1, wherein after the step of adding the first tab to the tab group and closing the grouping interface, the method further comprises:
receiving a selection operation performed on the second tab; and
extendedly displaying the grouping interface from the second tab.

5. The method of grouping and managing web pages as claimed in claim 4, wherein after the step of extendedly displaying the grouping interface from the second tab, the method further comprises:
receiving the drag operation performed on a third tab within the grouping interface; and
removing the third tab from the tab group and adding the third tab to the tab bar when the third tab is dragged to an empty area excluding the tabs in the tab bar by the drag operation and the drag operation is ended within the empty area.

6. The method of grouping and managing web pages as claimed in claim 4, wherein after the step of extendedly displaying the grouping interface from the second tab, the method further comprises:
receiving the drag operation performed on a fourth tab within the grouping interface; and
removing the fourth tab from the tab group and opening a new window for displaying the web page corresponding to the fourth tab when the fourth tab is dragged to an another area excluding the tab bar in the browser by the drag operation and the drag operation is ended within the other area.

7. The method of grouping and managing web pages as claimed in claim 1, wherein after the step of adding the first tab to the tab group and closing the grouping interface, the method further comprises:
receiving a selection operation performed on the second tab; and
pulling down a tab list comprising all of the tabs in the tab group from the second tab.

8. The method of grouping and managing web pages as claimed in claim 7, wherein after the step of pulling down the tab list comprising all of the tabs in the tab group from the second tab, the method further comprises:
receiving the drag operation performed on a fifth tab in the tab list; and
removing the fifth tab from the tab group and adding the fifth tab to the tab bar when the fifth tab is dragged to an empty area excluding the tabs in the tab bar by the drag operation and the drag operation is ended within the empty area.

9. The method of grouping and managing web pages as claimed in claim 7, wherein after the step of pulling down the tab list comprising all of the tabs in the tab group from the second tab, the method further comprises:
receiving the drag operation performed on a sixth tab in the tab list; and
removing the sixth tab from the tab group and opening a new window for display the web page corresponding to the sixth tab when the sixth tab is dragged to an another area excluding the tab bar in the browser by the drag operation and the drag operation is ended within the other area.

10. The method of grouping and managing web pages as claimed in claim 7, wherein after the step of pulling down the tab list comprising all of the tabs in the tab group from the second tab, the method further comprises:
receiving the drag operation performed on a seventh tab of the tabs in the tab bar; and
adding the seventh tab to the tab group and displaying the seventh tab in the tab list when the seventh tab is dragged to the tab list by the drag operation.

11. The method of grouping and managing web pages as claimed in claim 1, wherein after the step of adding the first tab to the tab group and closing the grouping interface, the method further comprises:
receiving a double-click operation performed on the second tab; and
extendedly displaying all of the tabs in the tab group from the second tab in the tab bar.

12. The method of grouping and managing web pages as claimed in claim 1, wherein the step of adding the first tab to the tab group and closing the grouping interface further comprise:
displaying a search bar in the second tab; and
receiving text entered in the search bar by a user, and accordingly searching the tab corresponding to the text in the tab group.
